(19) United States
(12) Patent Application Publication
(10) Pub. No.: US 2021/0192409 A1
(43) Pub. Date: Jun. 24, 2021

(54) DYNAMIC CHARGING DEMAND SIDE RESPONSE METHOD AND DYNAMIC CHARGING DEMAND SIDE MANAGEMENT METHOD BASED ON CONSUMER ORDER, AND DEMAND SIDE MANAGEMENT CONTROL SYSTEM FOR PERFORMING THE METHODS

(71) Applicant: Electronics and Telecommunications Research Institute, Daejeon (KR)

(72) Inventor: Seok-jin LEE, Daejeon (KR)

(21) Appl. No.: 17/123,552

(22) Filed: Dec. 16, 2020

(30) Foreign Application Priority Data
Dec. 20, 2019 (KR) 10-2019-0172328
Dec. 8, 2020 (KR) 10-2020-0170708

(51) Int. Cl. G06Q 10/06; H02J 3/00; H02J 7/00; G06Q 50/06; G06Q 30/02; G06Q 10/10; G06Q 50/18; G05B 19/042; B60L 53/64; B60L 53/62

(52) U.S. Cl. CPC G06Q 10/06315; H02J 3/003; H02J 7/007188; G06Q 50/06; G06Q 30/0206; G05B 2219/25357; G06Q 50/18; G05B 19/042; B60L 53/64; B60L 53/62; G06Q 10/10

(57) ABSTRACT

A dynamic charging demand side response method and a dynamic charging demand side management method based on a consumer order, and a demand side management control system for performing the methods. In favor of a consumer, a controllable reduction capacity may be increased by securing a number of flexible blocking measures suitable for characteristics of target load, thereby performing efficient demand management.

### CROSS-REFERENCE TO RELATED APPLICATION(S)

This application claims the priority benefit of Korean Patent Application No. 10-2019-0172328 filed on Dec. 20, 2019, and Korean Patent Application No. 10-2020-0170708 filed on Dec. 8, 2020, in the Korean Intellectual Property Office, the disclosures of which are incorporated herein by reference for all purposes.

### BACKGROUND

### 1. Field of the Invention

Example embodiments relate to a dynamic charging demand side response method and a dynamic charging demand side management method based on a consumer order, and a demand side management control system for performing the methods, more particularly, to a method and apparatus for managing a demand side response more flexibly by performing dynamic charging so as to increase the economy and independence of operation in an energy cloud environment.

### 2. Description of Related Art

In recent years, with growing demand for, technical measures have been developed to balance supply with the demand for energy. In particular, electric energy requires a large amount of investment in supply equipment because a balance between supply and demand is sensitive every moment.

A balance stabilization technology in energy supply and demand has a method that contributes both a supplier side and a consumer side. It is economically known to stabilize the demand side, rather than relying solely on supply-oriented investment.

In particular, when a demand side management effect linked to fluctuations in energy supply is strengthened, it is possible to reduce a cost for supply stabilization. Here, demand side management (DSM) denotes a plan or activity in which a power company reasonably controls and adjusts a type of electricity usage of the demand side.

Demand side management measures utilize: \textcircled{1} “demand side management policy” that promotes strategic consumption savings, for example, an incentive system for improving the efficiency of electric equipment, \textcircled{2} a “differential rate” policy for each season and time period for load management, and \textcircled{3} a policy to suppress or block demand-side load.

Among the demand side management measures, the differential rate method allows users to reduce power consumption through the implementation of a differential rate system for each season and time period, or induces a power usage pattern so as to avoid power usage in a specific time period, thereby maintaining a balance between a power supply capacity and a consumption within a wide time period.

When there is a crisis in power supply and demand, in order to maintain the balance of supply and demand through electric rate adjustment or power saving by instruction to reduce load, an incentive-based demand side response (a mechanism that allows consumers to respond according to a power supply situation, a peak load rate, and a power production/supply price) system is also utilized.

However, when the demand-side load is strongly suppressed or blocked, it is difficult for the consumers because they have no measure for selection.

### SUMMARY

An aspect provides a method and apparatus for increasing a capacity of a demand side response resource capable of flexible demand side management that is capable of contributing to improvement of independence of operation in an energy cloud environment.

Another aspect provides a method and apparatus capable of managing a dynamic charging demand side response (DR) based on a consumer order by increasing a control capacity of a demand side response resource using a charge-type load characteristic.

According to an aspect, there is provided a dynamic charging demand side management method including receiving charging order information for energy supply from a charger control apparatus, determining a supply unit price in consideration of the charging order information and an energy state at an operation time point when energy supply is possible, and providing, to the charger control apparatus, a charging control signal for executing energy supply according to the supply unit price.

The receiving may include receiving charging order information including at least one of a charging operation time (Hour), an ordered energy capacity (kWh), and a maximum operation rating (kW) indicating an energy consumption pattern, and the charging operation time may denote time information in which an entire order operation period including an operation end period is identifiable.

The determining may include determining an energy supply unit price in consideration of a time interval between a consumption start time point and a consumption end time point based on the charging order information within the operation time point when energy supply is possible.

The providing may include transmitting the determined supply unit price to a charger control apparatus, receiving a request for a supply contract based on the supply unit price from the charger control apparatus, and transmitting a charging control signal for executing energy supply to the charger control apparatus in response to the requested supply contract.

The providing may include transmitting a charging execution signal for executing energy supply in response to each of a plurality of consumption start time points that are occurrable discontinuously within a charging operation time of the charging order information.

The providing may include providing a charging execution signal including a charging execution command for inducing energy consumption at a time point when power supply margin based on the energy state occurs, or a charging suspend command.

According to another aspect, there is a dynamic charging demand side response method may include providing charging order information inputted by a consumer to a power demand side management apparatus, receiving an energy supply price based on charging order information from the power demand side management apparatus, determining a supply contract at the energy supply price, receiving a charging execution signal for executing energy supply from the power demand side management apparatus according to the determined supply contract, and switching a charging time point for energy supply according to the charging execution signal. The power demand side management apparatus may be configured to transmit the charging execution signal for executing energy supply in response to each of a plurality of consumption start time points that are occurrable discontinuously in response to a charging operation time of the charging order information.

The providing may include providing, to the power demand side management apparatus, charging order information including at least one of a charging operation time (Hour), an ordered energy capacity (kWh), and a maximum operation rating (kW) indicating an energy consumption pattern

The charging execution signal may include a charging execution command for inducing energy consumption at a time point when power supply margin occurs, or a charging suspend command.

The switching may include switching a charging time point for discontinuous charging or charging with a variable value based on an energy state at an operation time point when energy supply is possible on the basis of the charging order information.

According to still another aspect, there is provided a power demand side management apparatus including a processor. The processor may be configured to receive charging order information for energy supply from a charger control apparatus, determine a supply unit price in consideration of the charging order information and an energy state at an operation time point when energy supply is possible, and provide, to the charger control apparatus, a charging control signal for executing energy supply according to the supply unit price.

The processor may be configured to receive charging order information including at least one of a charging operation time (Hour), an ordered energy capacity (kWh), and a maximum operation rating (kW) indicating an energy consumption pattern.

The processor may be configured to determine a supply unit price in consideration of a time interval between a consumption start time point and a consumption end time point based on the charging order information within the operation time point when energy supply is possible.

The processor may be configured to transmit the determined supply unit price to a charger control apparatus, receive a request for a supply contract based on the supply unit price from the charger control apparatus, and transmitting a charging control signal for executing energy supply to the charger control apparatus in response to the requested supply contract.

The processor may be configured to transmit a charging execution signal for executing energy supply in response to each of a plurality of consumption start time points that are occurrable discontinuously within a charging operation time of the charging order information.

The processor may be configured to provide a charging execution signal including a charging execution command for inducing energy consumption at a time point when power supply margin based on the energy state occurs, or a charging suspend command.

According to still another aspect, there is provided a charger control apparatus including a processor. The processor may be configured to provide charging order information inputted by a consumer to a power demand side management apparatus, receive an energy supply price based on the charging order information from the power demand side management apparatus, determine a supply contract at the energy supply price, receive a charging execution signal for executing energy supply from the power demand side management apparatus according to the determined supply contract, and switch a charging time point for energy supply according to the charging execution signal. The power demand side management apparatus may be configured to transmit the charging execution signal for executing energy supply in response to each of a plurality of consumption start time points that are occurrable discontinuously or with a variable value in response to a charging operation time of the charging order information.

The processor may be configured to provide, to the power demand side management apparatus, charging order information including at least one of a charging operation time (Hour), an ordered energy capacity (kWh), and a maximum operation rating (kW) indicating an energy consumption pattern.

The charging execution signal may include a charging execution command for inducing energy consumption at a time point when power supply margin occurs, or a charging suspend command.

The processor may be configured to switch a charging time point for discontinuous charging based on an energy state at an operation time point when energy supply is possible on the basis of the charging order information.

Additional aspects of example embodiments will be set forth in part in the description which follows and, in part, will be apparent from the description, or may be learned by practice of the disclosure.

According to example embodiments, a dynamic charging demand side management method for contributing to improvement of independence of operation in an energy cloud environment may induce an increase in a capacity of a demand side response resource to enable more flexible demand side management for reduction in charge-type load.

According to example embodiments, a dynamic charging demand side management method may increase a control capacity of a demand side response resource using a charge-type load characteristic, thereby managing a dynamic charging demand side response based on a consumer order.

According to example embodiments, a dynamic charging demand side response method, which is an order-based demand side response measure to which a new load characteristic such as battery charging are reflected, may contribute as a measure for securing stability of a small-scale power system.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a demand side management control system according to an example embodiment;

FIG. 2 is a diagram illustrating an operation between a power demand side management apparatus and a charger control apparatus according to an example embodiment;

FIGS. 3A and 3B are diagrams illustrating an operation of determining a power unit price according to a supply time point on the basis of charging order information according to an example embodiment;

FIG. 4 is a diagram illustrating respective procedures for dynamically controlling energy supply according to charging order information according to an example embodiment; and

FIGS. 5A to 5C illustrate an interface of a charger control apparatus for inputting charging order information according to an example embodiment.

### DETAILED DESCRIPTION

Hereinafter, example embodiments will be described in detail with reference to the accompanying drawings.

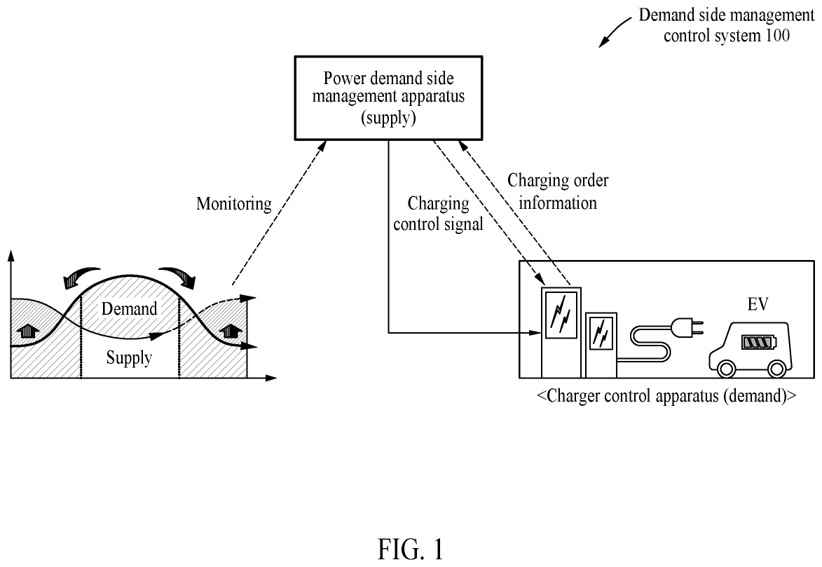

FIG. 1 is a diagram illustrating a demand side management control system according to an example embodiment.

Referring to FIG. 1, a demand side management control system 100, which is a connection structure of dynamically managing a charge-type demand side response based on a consumer order, may include a power demand side management apparatus 101 and a charger control apparatus 102 therefor. Here, the power demand side management apparatus 101 may be an apparatus that operates from a viewpoint of a supplier that supplies power, and the charger control apparatus 102 may be an apparatus that operates from a viewpoint of a consumer that charges power.

The demand side management control system 100 may have a structure of controlling the charger control apparatus 102 in real time through the power demand side management apparatus 101 at a power consumption time point for consumer charging. The demand side management control system 100 may perform discontinuous charging so as to control the power consumption time point of the charger control apparatus 102 for more favorable operation in terms of supply.

In other words, the demand side management control system 100, which dynamically controls a power consumption point of the charger control apparatus 102 in real time through the power demand side management apparatus 101, may suspend demand of a time when peak load increases and distribute a power consumption point of a charger, thereby securing flexibility in terms of operation of the power demand side management apparatus. Here, the demand side management control system 100 may conclude a supply contract between the power demand side management apparatus 101 and the charger control apparatus 102 based on charging order information 103 of the consumer secured through the charger control apparatus 102, thereby performing charging discontinuously or with a variable value to be more favorable in terms of supply. Here, discontinuous or a variable value may denote “a value that is controlled to be variable” rather than a constant value (ON/OFF).

Specifically, the charger control apparatus 102 may receive charging order information 103 for energy supply from a consumer who desires to charge. The charger control apparatus 102 may transmit the charging order information 103 to the power demand side management apparatus 101, and the power demand side management apparatus 101 may receive the charging order information 103 transmitted from the charger control apparatus 102.

Thereafter, the power demand side management apparatus 101 may determine a supply unit price in consideration of the charging order information 103 and an energy state at an operation time point when energy supply is possible. The power demand side management apparatus 101 may determine the supply unit price in consideration of a time interval between a consumption start time point and a consumption end time point based on the charging order information 103 within the operation time point in which energy supply is possible. In this case, the power demand side management apparatus 101 may use a time point when power supply margin occurs, that is, an unused time within a charging operation time of the charging order information 103, thereby setting a time interval between an intermittent consumption start time point and consumption end time point while avoiding a peak time for power charging. Such supply operation time margin of the charging order information 103 may lead to a reduction in supply cost.

The power demand side management apparatus 101 may conclude the supply contract with the charger control apparatus 102 on the basis of the charging order information 103 by transmitting the determined supply unit price to the charger control apparatus 102. The power demand side management apparatus 101 may induce the consumer to conclude the supply contract at a more reasonable supply unit price.

When the supply contract is concluded, the power demand side management apparatus 101 may provide, to the charger control apparatus 102, a charging control signal 104 for executing energy supply according to the supply unit price. In this case, the power demand side management apparatus 101 may transmit the charging execution signal 104 for executing energy supply in response to each of a plurality of consumption start time points that are occurrable discontinuously or with a variable value within the charging operation time of the charging order information 103. The charging execution signal 104 may include a charging execution command for inducing energy consumption at a time point when the power supply margin based on the energy state occurs or a charging suspend command.

The charger control apparatus 102 may supply charging power by switching a charging time point for supplying energy according to the charging execution signal 104 transmitted discontinuously or with a variable value. Here, the charger control apparatus 102 may supply, to a charging target apparatus, charging power having different charging-allowing capacities at different time points when the charging execution signal 104 based on an ordered energy capacity of the charging order information 103 is transmitted.

Accordingly, the demand side management control system 100 may reflect a charging promotion on the basis of details included in the charging order information 103, a power supply situation, and a supply policy, thereby controlling the power demand side management apparatus 101 and the charger control apparatus 102 so as to facilitate a smooth transaction therebetween.

For example, the demand side management control system 100 may perform a dynamic charging demand side management method and a dynamic charging demand supply method based on the charging order information through respective apparatuses when charging an electric vehicle. When a supply wire is connected for charging of an electric vehicle in a small-scale power network such as a microgrid, the demand side management control system 100 may improve a method in which charging is immediately started from a time point of connection to a grid, and accordingly may apply the dynamic charging demand side management method and the dynamic charging demand side response method.

The dynamic charging demand side management method may be a method for demand side management (a plan or activity of the supplier to induce a demand side response), the method through which energy is dynamically charged, performed by the power demand side management apparatus. Here, “demand side response” may denote a mechanism by which the consumer may respond according to the power supply situation. In addition, the dynamic charging demand side response method may denote a consumer-side operation of the consumer dynamically submitting an order form and participating in the demand side management.

The charger control apparatus 102 may receive the charging order information 103 from the consumer at a time point when the electric vehicle is connected to the small-scale power network. The charger control apparatus 102 may transmit the charging order information 103 to the power demand side management apparatus 101.

The power demand side management apparatus 101 may provide the charging control signal 104 to the charger control apparatus 102 at a time point which is more favorable in terms of demand stabilization in a power supply process. In this case, the power demand side management apparatus 101 may transmit the charging power controlled according to the charging control signal 104 to the charger control apparatus 102 through a power line. In this case, a supply side of the power demand side management apparatus 101 may control charging of the charger control apparatus 102 by calculating the power consumption time point so as to secure a total amount of ordered energy of the charging order information 103 ordered by the consumer.

A consumer showing a consumption pattern such as charging of a battery of the electric vehicle may designate a charging period for securing necessary energy corresponding to the ordered energy capacity, and thus it may be favorable for order-based demand side management suggested by example embodiments. In addition, when a favorable condition for supply operation is secured to balance demand and supply, supply costs may be reduced. When power supply costs are reduced, a benefit may be provided to the consumer at a promotional price.

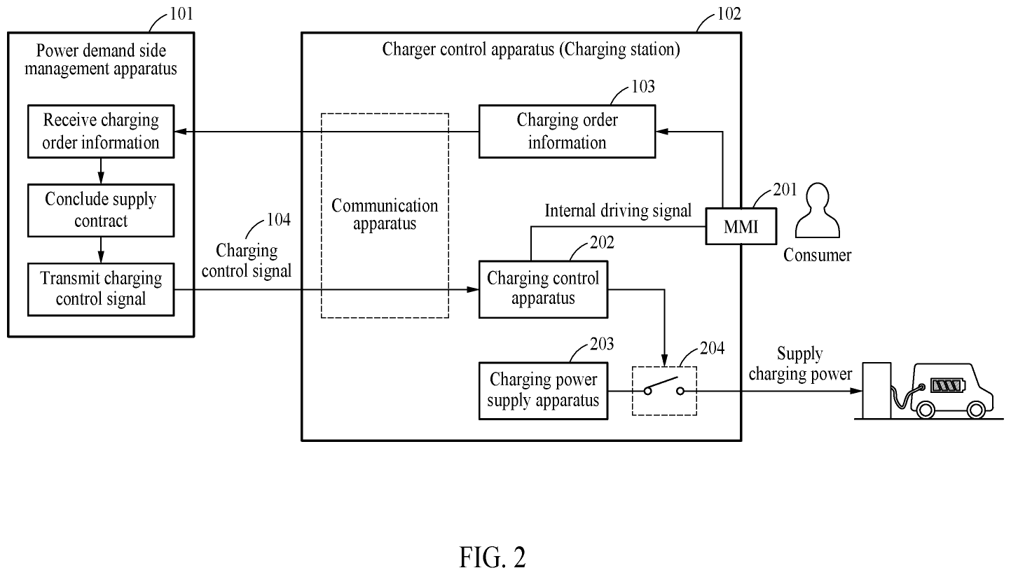

FIG. 2 is a diagram illustrating an operation between a power demand side management apparatus and a charger control apparatus according to an example embodiment.

Referring to FIG. 2, the power demand side management apparatus 101 may receive the charging order information 103 for energy supply from the charger control apparatus 102. The power demand side management apparatus 101 may determine the supply unit price in consideration of the charging order information 103 and the energy state at the operation time point when energy supply is possible. The power demand side management apparatus 101 may conclude the supply contract with the charger control apparatus 102 based on the supply unit price. When the supply contract is concluded, the power demand side management apparatus 101 may provide, to the charger control apparatus 102, the charging control signal 104 for executing energy supply according to the supply unit price.

The charger control apparatus 102 may show a block diagram of an internal function for performing a dynamic charging demand side response function based on the charging order information. Specifically, the charger control apparatus 102 may include a man-machine interface (MMI) 201, a charging control apparatus 202, a charging power supply apparatus 203, and a switch 204.

The MMI interface 201, which is an interface for connecting the consumer and the charger control apparatus 102 to each other, may receive the charging order information 103 for energy supply from the consumer who desires to charge. The MMI interface 201 may transmit, to the charging control apparatus 202, an internal driving signal based on an operation of the consumer. The internal driving signal may be a standby signal for operation of the charger control apparatus 102. In addition, the charger control apparatus 102 may provide the charging order information 103 received through the MMI interface 201 to the power demand side management apparatus 101.

The charging control apparatus 202 may receive the charging control signal 104 from the power demand side management apparatus 101. The charging control apparatus 202 may control the switch 204 according to a command included in the charging control signal 104. In other words, the charging control apparatus 202 may identify whether the charging control signal 104 is the charging execution command for inducing energy consumption, the charging suspend command, or a command to maintain a low value.

The charging control apparatus 202 may control the switch 204 to be in an “ON” state or an “OFF” state or adjust the switch 204 to have a higher or lower value according to the identified command. For example, when the charging control signal 104 is the charging execution command, the charging control apparatus 202 may control the state of the switch 204 from “OFF” to “ON”, or control the switch 204 to be maintained in the “ON” state. In addition, when the charging control signal 104 is the charging suspend command, the charging control apparatus 202 may control the state of the switch 204 from “ON” to “OFF” or control the switch 204 to be maintained in the “OFF” state.

The charging power supply apparatus 203 may supply charging power to the charging target apparatus when the switch 204 is maintained or controlled in the “ON” state.

Here, since the power demand side management apparatus 101 directly controls a charging consumption time point of a remote location on the basis of the charging order information 103 of the consumer in terms of the supplier, demand side management operation and rate calculation may be performed without hourly meter reading. In addition, when the power demand side management apparatus 101 includes hourly meter reading, stability may be increased in terms of redundancy, however, the power demand side management 101 may have a structure capable of reducing a burden of hourly meter reading.

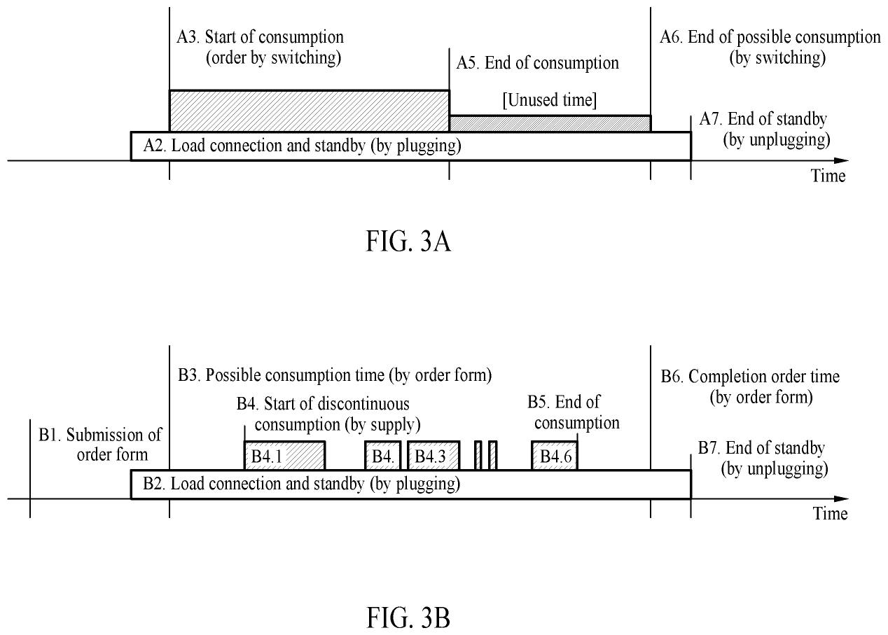

FIGS. 3A and 3B are diagrams illustrating an operation of determining a power unit price according to a supply time point on the basis of charging order information according to an example embodiment.

Referring to FIGS. 3A and 3B, the demand side management control system 100 may consider consumption characteristics of battery charging based on the charge-type load. Here, the charge-type load may denote a type that is satisfied when energy with a desired capacity is accumulated and supplied within a predetermined period. The demand side management control system 100 may acquire an energy capacity within the predetermined period by accumulating charging power based on the consumption characteristics of battery charging.

According to example embodiments, there may exist room for adjustment of the consumption time point so that the peak time is avoided when the unused time remains. Specifically, the charging order information inputted by the consumer for charging may include at least one of a charging operation time (Hour), an ordered energy capacity (kWh), and a maximum operation rating (kW) indicating an energy consumption pattern. Here, the charging operation time (Hour) may include a start order time and an end order time. The charging order information may be indicated as in Table 1 below.

TABLE 1

| | Order form details | | |
|---|---|---|---|
| | (charging order | | |
| Item | information) | Unit | |
| C1 | Possible consumption | Time (date, hour, | Charging-allowing |
| | time (possible | minute, second) | maximum operation |
| | charging time) | | period ← (C2-C1) |
| C2 | Completion order | Time (date, hour, | [Hour] |
| | time (charging | minute, second) | |
| | complete request | | |
| | time) | | |
| C3 | Total amount of | kWh | Maximum chargeable |
| | ordered energy | | energy during period of |
| | (amount of energy | | order form ← |
| | requested to be | | C4[kW] * (C2-C1) |
| | charged) | | [Hour] |
| C4 | Operable maximum | kW | |
| | rating (charging- | | |
| | allowing rating) | | |
| C5 | Load equipment ID | English numeral | |

An accumulated amount of charged energy may be denoted by Equation 1 below.

Accumulated amount of charged energy=C4*k1*(C2−C1)*k2 [Equation 1]

Here, C1 may denote a start order time, and the start order time may include a possible consumption time and a possible charging time. C2 may denote a complete order time. C4 may denote an operable maximum rating (kW). K1 may denote an operation ratio to a maximum rating. K2 may denote an operating ratio of a maximum operation period. Here, according to example embodiments, a time interval width between a start and an end of the order form for securing “ordered energy capacity” of the charging order information may not only provide flexibility in operation of a supply time point, but also affect an electricity supply unit price. The graph of FIG. 3A illustrates a form of existing consumption, and the graph of FIG. 3B illustrates a form of discontinuous consumption or a form of consumption with a variable value suggested by example embodiments. As a result, according to example embodiments, when supplying “requested energy capacity” to the consumer within an ordered time period, the supplier may control different charging consumption time points in real time so that consumption occurs at the time point when the power supply margin occurs.

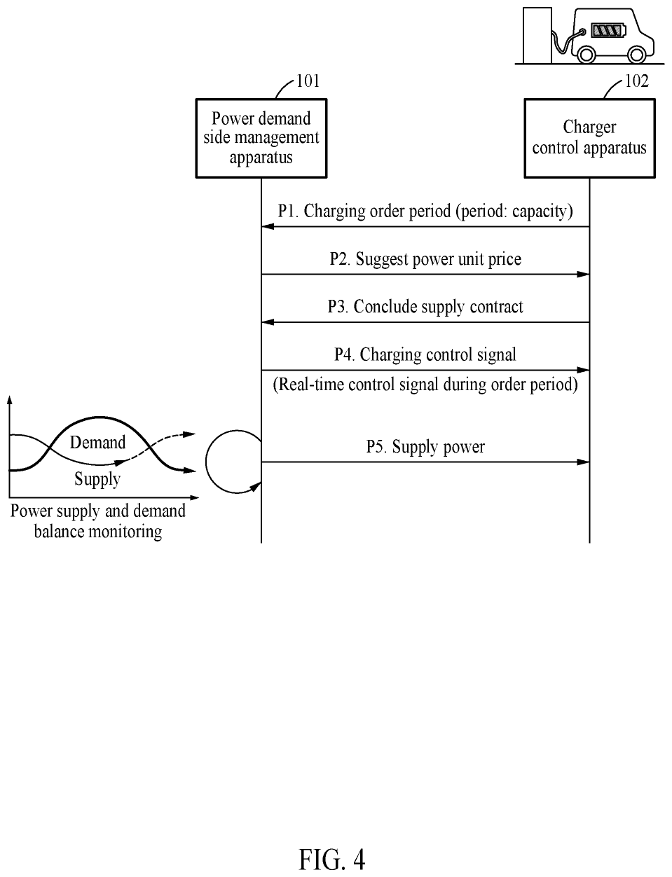

FIG. 4 is a diagram illustrating respective procedures for dynamically controlling energy supply according to charging order information according to an example embodiment.

Referring to FIG. 4, in P1, the charger control apparatus 102 may provide the charging order information inputted by the consumer to the power demand side management apparatus. The charging order information may be information inputted through the MMI in order for the consumer to receive energy. The charging order information may include the possible consumption time, the completion order time, the total amount of ordered energy, and the operable maximum rating.

In P2, the power demand side management apparatus 101 may determine the supply unit price in consideration of the possible consumption time, the completion order time, the total amount of ordered energy, the operable maximum rating, and the energy state at the supply time point included in the charging order information. The supply unit price may include a promotional price reflecting a contribution to operational cooperation. The power demand side management apparatus 101 may transmit the supply unit price including the promotional price to the charger control apparatus 102.

In P3, according to example embodiments, the supply contract may be concluded when there is no rejection from the charger control apparatus 102. According to example embodiments, when a button control for cancellation is not performed on the MMI of the charger control apparatus 102, it is possible to identify the supply contract between the power demand side management apparatus 101 and the charger control apparatus 102, that is, between the supplier and the consumer, as being permitted and to conclude the supply contract.

In P4, the power demand side management apparatus 101 may provide the charging control signal to the charger control apparatus 102 while monitoring power demand. The charger control apparatus 102 may start an energy consumption process based on the charging control signal, which may operate in a form of intermittent consumption including execution and suspend of charging based on the charging control signal.

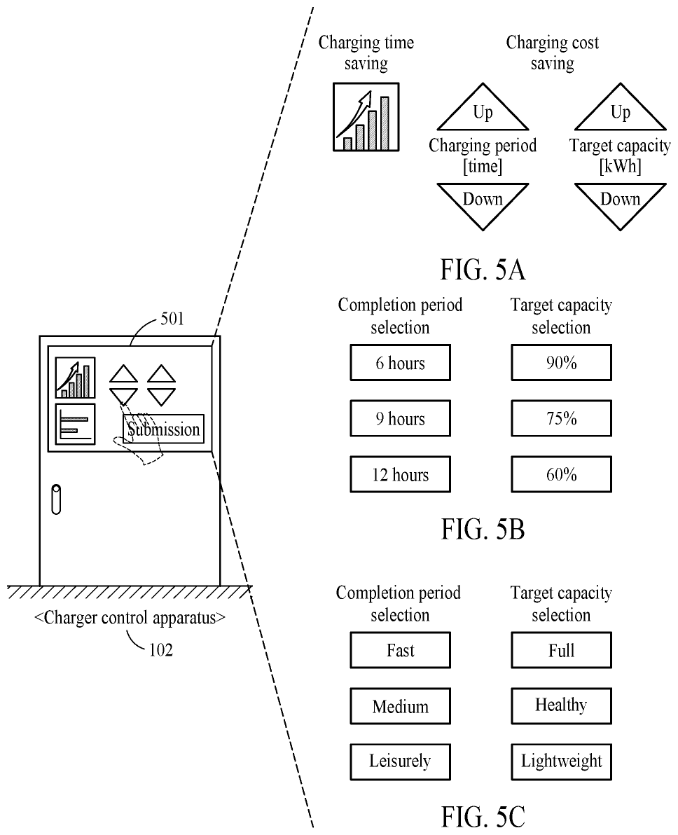

FIGS. 5A to 5C illustrate an interface of a charger control apparatus for inputting charging order information according to an example embodiment.

Referring to FIGS. 5A to 5C, the charger control apparatus 102 may provide an order form submission UI 501 for inputting the charging order information. In this case, the charger control apparatus 102 may supply energy for the purpose of reducing a charging time. The order form submission UI 501 may be classified into two types below.

1) Order form submission UI submitted through a certified mobile phone application

2) After authenticating a consumer (or user) through the MMI linked with the charger control apparatus 102, the order form submission UI for inputting order details with a display and a button

The order form submission UI 501 may provide various buttons illustrated in FIG. 5A to 5C.

The order form submission UI 501 of FIG. 5A, which is an example of the MMI in which the charging order information may be inputted, may include an increase/decrease button capable of controlling a charging period and a value of a target capacity, for example, a state of charge.

The order form submission UI 501 of FIG. 5B, which is an example of the MMI in which the charging order information may be inputted, may include a numeric one-touch selection button capable of controlling the charging period and the target capacity value.

The order form submission UI 501 of FIG. 5C, which is an example of an MMI in which the charging order information may be inputted, may include a semantic one-touch selection button capable of controlling the charging period and a charge capacity value.

The buttons provided to the order form submission UI 501 illustrated in FIG. 5A to 5B may mainly divided and provided into the charging period and a charge capacity.

\textcircled{1} Charging Period

An initial display value of the charging period may be an initial setting value of a user or a factory setting value set as default. A constant display value of the charging period may reflect a user experience value as big data.

A user input for a charging period value may change the value with the increase/decrease button. The user input for the charging period value may use the numeric one-touch button indicating fast/medium/leisurely. The user input for the charging period value may use the semantic one-touch button, which denotes fast/medium/leisurely.

\textcircled{2} Target Capacity

A unit of the target capacity may be denoted as an absolute capacity (kWh) or a charging-allowing relative capacity (%), and an initial display value of the target capacity may be set as an initial setting value of a user or a factory setting value. In addition, a constant display value of the target capacity may reflect an existing charging experience value as big data.

Here, a user input for a target capacity value may change the value with an increase/decrease button. The user input for selecting a completion period may be selected with the numeric one-touch button indicating full/healthy/lightweight. The user input for the target capacity value may be selected with the semantic one-touch button indicating full/healthy/lightweight.

Among the buttons of the target capacity, healthy may denote charging to a level that is favorable to a battery life recommended by a manufacturer, and a charging rate of a corresponding button may be estimated as a value of about 75%, and the charging rate may be changed to a user setting value.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, that is, a computer program tangibly embodied in an information carrier, for example, in a machine-readable storage apparatus (for example, a computer-readable medium) or in a propagated signal for processing by, or to control an operation of a data processing apparatus, for example, a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. In general, a processor will receive instructions and data from a read-only memory or a random access memory or both. Elements of a computer may include at least one processor to execute instructions and one or more memory apparatus to store instructions and data. In general, a computer will also include or be coupled to receive data from, transfer data to, or perform both on one or more mass storage apparatus to store data, for example, magnetic, magneto-optical disks, or optical disks. Examples of information carriers suitable for embodying computer program instructions and data include semiconductor memory apparatus, for example, magnetic media such as a hard disk, a floppy disk, and a magnetic tape, optical media such as a compact disk read only memory (CD-ROM), a digital video disk (DVD), and the like, and magneto-optical media such as a floptical disk, and a read only memory (ROM), a random access memory (RAM), a flash memory, an erasable programmable ROM (EPROM), and an electrically erasable programmable ROM (EEPROM). A processor and a memory may be supplemented by, or integrated into, a special purpose logic circuit.

In addition, non-transitory computer-readable media may be any available media that may be accessed by a computer and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products.

It should be understood that example embodiments disclosed herein are merely illustrative and are not intended to limit the scope of the invention. It will be apparent to those skilled in the art that various modifications of the example embodiments may be made without departing from the spirit and scope of the claims and their equivalents.

What is claimed is:

1. A dynamic charging demand side management method comprising:
receiving charging order information for energy supply from a demand side;
determining a supply unit price in consideration of the charging order information and an energy state at an operation time point when energy supply is possible, wherein the supply unit price denotes unit value amount information comprising a basic cost and a management support fund; and
providing, to the charger control apparatus, a charging control signal for executing energy supply according to the supply unit price.

2. The method of claim 1, wherein:
the receiving comprises receiving charging order information comprising at least one of a charging operation time (Hour), an ordered energy capacity (kWh), and a maximum operation rating (kW) indicating an energy consumption pattern, and
the charging operation time denotes a period in which charging is requested to be completed.

3. The method of claim 1, wherein the determining comprises determining an energy supply unit price in consideration of a time interval between a consumption start time point and a consumption end time point based on the charging order information within the operation time point when energy supply is possible.

4. The method of claim 1, wherein the providing comprises:
transmitting the supply unit price to a demand side;
receiving a request for a supply contract based on the supply unit price from a charger control apparatus of the demand side; and
transmitting a charging control signal for executing energy supply to the charger control apparatus in response to the requested supply contract.

5. The method of claim 1, wherein the providing comprises transmitting a charging execution signal for executing energy supply in response to each of a plurality of consumption start time points that are occurrable discontinuously or with a variable value within a charging operation time of the charging order information.

6. The method of claim 1, wherein the providing comprises providing a charging execution signal comprising a charging execution command for inducing energy consumption at a time point when power supply margin based on the energy state occurs, or a charging suspend command.

7. A dynamic charging demand side response method comprising:
providing charging order information inputted by a consumer to a power demand side management apparatus;
receiving energy supply cost information based on charging order information from the power demand side management apparatus, wherein the supply cost information denotes unit value amount information comprising a basic cost and a management support fund;
determining a supply contract by using the energy supply cost information;
receiving a charging execution signal for executing energy supply from the power demand side management apparatus according to the determined supply contract; and
switching a charging time point for energy supply according to the charging execution signal,
wherein the power demand side management apparatus is configured to transmit the charging execution signal for executing energy supply in response to each of a plurality of consumption start time points that are occurrable discontinuously or with a variable value within a charging operation time of the charging order information.

8. The method of claim 7, wherein:
the providing comprises providing, to the power demand side management apparatus, charging order information comprising at least one of a charging operation time (Hour), an ordered energy capacity (kWh), and a maximum operation rating (kW) indicating an energy consumption pattern, and
the charging operation time denotes a period in which charging is requested to be completed.

9. The method of claim 7, wherein the charging execution signal comprises a charging execution command for inducing energy consumption at a time point when power supply margin occurs, or a charging suspend command.

10. The method of claim 7, wherein the switching comprises switching a charging time point for discontinuous charging based on an energy state at an operation time point when energy supply is possible on the basis of the charging order information.

11. A power demand side management apparatus, the power demand side management apparatus comprising a processor, wherein the processor is configured to:
receive charging order information for energy supply from a charger control apparatus;
determine a supply unit price in consideration of the charging order information and an energy state at an operation time point when energy supply is possible; and
provide, to the charger control apparatus, a charging control signal for executing energy supply according to the supply unit price.

12. The apparatus of claim 11, wherein the processor is configured to receive charging order information comprising at least one of a charging operation time (Hour), an ordered energy capacity (kWh), and a maximum operation rating (kW) indicating an energy consumption pattern.

13. The apparatus of claim 11, wherein the processor is configured to determine a supply unit price in consideration of a time interval between a consumption start time point and a consumption end time point based on the charging order information within the operation time point when energy supply is possible.

14. The apparatus of claim 11, wherein the processor is configured to:
transmit the determined supply unit price to a charger control apparatus;
receive a request for a supply contract based on the supply unit price from the charger control apparatus; and
transmitting a charging control signal for executing energy supply to the charger control apparatus in response to the requested supply contract.

15. The apparatus of claim 11, wherein the processor is configured to transmit a charging execution signal for executing energy supply in response to each of a plurality of consumption start time points that are occurrable discontinuously within a charging operation time of the charging order information.

16. The management apparatus of claim 11, wherein the processor is configured to provide a charging execution signal comprising a charging execution command for inducing energy consumption at a time point when power supply margin based on the energy state occurs, or a charging suspend command.
